(19) United States
(12) Patent Application Publication
(10) Pub. No.: US 2024/0024919 A1
(43) Pub. Date: Jan. 25, 2024

(54) UNLOADING TABLE FOR SORTING PARTS

(71) Applicant: Feralloy Corporation, Chicago, IL (US)

(72) Inventors: Bruce Alan McCurdy, Valley Head, AL (US); Cody Dane Works, Fort Payne, AL (US); Alex D. Whitmore, Fort Payne, AL (US)

(21) Appl. No.: 18/081,214

(22) Filed: Dec. 14, 2022

Related U.S. Application Data
(60) Provisional application No. 63/391,405, filed on Jul. 22, 2022.

(51) Int. Cl. B07B 13/16; B23Q 11/00

(52) U.S. Cl. CPC B07B 13/16; B23Q 11/0057

(57) ABSTRACT

An unloading table for sorting items that functions to remove scrap material that can be slid off the tabletop into a top opening of a collection chute that surrounds the perimeter of the top of the table. A center structure is arranged within the collection chute and includes a frame having members arranged to support the tabletop in a flat, horizontal plane. The collection chute of the unloading table has a through passage that connects its top opening surrounding the tabletop to a bottom opening thereof. The through passage of the chute is formed by walls, one of at least has a sloped wall surface for guiding scrap material to the bottom opening for collection.

### TECHNICAL FIELD

This application claims the benefit of U.S. provisional application Ser. No. 63/391,405 filed Jul. 22, 2022, the contents of which are incorporated herein in their entirety by reference.

### TECHNICAL FIELD

The present disclosure relates to a table structure for sorting items or parts, and more particularly, an unloading table structure for sorting parts arranged in sheets and discarding sorted scrap material within the table structure.

### BACKGROUND

In the metal-cutting industry, cut parts must be separated from stock sheets. Separating cut parts from stock sheets is labor intensive and time consuming, and often generates scrap material that must be discarded. Scrap material can range in size and shape depending on the cut parts and frequently accumulates on the floor as parts are removed from the stock sheets used in the cutting process. The scrap material must then be collected and removed. A further disadvantage is that cut parts can sometimes become mixed in with scrap material and mistakenly discarded.

There is a need to efficiently sort parts that are cut or stamped from stock sheets such that scrap material is easily removed and collected at a workstation. It is advantageous to have an intermediate collection or inspection tray to provide a user with a check area to confirm no parts have been erroneously sorted with scrap material. The present disclosure provides an unloading table that overcomes one or more difficulties related to sorting parts from stock sheets. The unloading table includes an elevated platform for sorting and scrap collection perimeter for efficiently removing unwanted material from the sorting area. The scrap collection perimeter optionally includes a shelf for a final sorting check to ensure parts are not mixed with scrap material.

### SUMMARY

Described herein are unloading tables having various features for aiding in sorting items while also being able to remove debris or scrap material off of the table for collection and subsequent removal. The table provides a simple, functional design that allows workers to be located at any position around the table to effectively sort through materials and easily discard sorted scrap or waste material for removal off the table into a collection chute for consolidating the scrap material for further processing.

In a first aspect, there is disclosed an unloading table for sorting items that functions to remove scrap material that can be slid off the table into a collection chute. The table includes a tabletop having a first surface, for example, an exposed sorting surface, and a second surface, opposite the second surface, for mounting onto a center structure of the table. The center structure includes a frame having members arranged to support the tabletop in a flat, horizontal plane. The table further includes a collection chute having a through passage that connects a top opening and a bottom opening thereof, and the through passage is formed by walls, one of at least has sloped wall surface. To support the tabletop, at least a portion of the center structure is positioned in the through passage of the collection chute.

In a second aspect, there is disclosed an unloading table for sorting, the table having a tabletop having a first surface and a second surface arranged in the middle of a through passage of a collection chute that surrounds the tabletop to provide a scrap removal means of an open gap between the perimeter of the tabletop and the top opening perimeter of the collection chute. Scrap material can be moved into the gap and allowed to fall through the through passage to exit through the bottom opening of the collection chute for further collection and processing. The collection chute is formed by at least four walls to define the through passage between the top opening and the bottom opening. The walls preferably include at least two walls having a sloped surface, the slope angled towards the center of the through passage to guide scrap material from the top opening to the smaller bottom opening below. The tabletop is supported by a center structure that includes a frame having a plurality of top members that provide a platform for holding the tabletop in a horizontal plane by contacting the second surface of the tabletop. The plurality of top members is joined to base members extending downward to provide a support base for the center structure to stand. The plurality of top members of the center structure are arranged to be within the top opening of the through passage of the collection chute such that the tabletop is supported and positioned within the top opening of the chute.

Any one of the above aspects (or examples of those aspects) may be provided alone or in combination with any one or more of the examples of that aspect discussed above; e.g., the first aspect may be provided alone or in combination with any one or more of the examples of the first aspect discussed above; and the second aspect may be provided alone or in combination with any one or more of the examples of the second aspect discussed above; and so-forth.

Additional features and advantages will be set forth in the detailed description which follows, and in part will be readily apparent to those skilled in the art from that description or recognized by practicing the embodiments as described herein, including the detailed description which follows, and the claims. It is to be understood that both the foregoing general description and the following detailed description are merely exemplary, and are intended to provide an overview or framework to understanding the nature and character of the claims.

### BRIEF DESCRIPTION OF THE DRAWINGS

The above and other features, examples and advantages of aspects or examples of the present disclosure are better understood when the following detailed description is read with reference to the accompanying drawings, in which:

FIG. 1 shows a perspective view of an unloading table having a raised table structure surrounded by one or more sloped sides.

FIG. 2 shows a perspective view of an unloading table having a raised table structure surrounded by one or more sloped sides with an inspection shelf.

FIG. 3 shows a perspective view of an unloading table having a tabletop forming a sorting surface positioned on top of a raised table structure.

FIG. 4 shows a perspective view of an unloading table without a center structure assembly to enhance the view to multiple collection carts positioned below the bottom opening of the collection chute of the unloading table.

### DETAILED DESCRIPTION

The terminology as set forth herein is for the description of the embodiments only and should not be construed as limiting the invention as a whole.

Herein, when a range such as 5-25 (or 5 to 25) is given, this means preferably at least or more than 5 and, separately and independently, preferably less than or not more than 25. In an example, such a range defines independently 5 or more, and separately and independently, 25 or less.

The present disclosure relates to tables for sorting parts from stock sheets housing the cut (e.g., laser cut) or stamped parts. The formed parts need to be separated from the stock sheets, for example, a thin metal sheet, and sorted from any non-part pieces before being removed from the table and stored for future use. Features of the table are described in detail below. For the features of the table, it is noted that all structures and individual members can be attached to one another by conventional methods, for example, fastener (e.g., screw, bolt, clip) or welding. As formed, the structures can be attached together to form the table as a whole. It is preferable that the structures and individual members are permanently attached to one another to ensure structural integrity of the table during use. Any suitable material can be used to form all structures and individual members of the table, for example, metal, stainless steel, plastic, composite materials, and combinations thereof can be used.

The internal, non-part pieces or other non-essential pieces, collectively together scrap material or debris, remaining from the separated parts and stock sheet can be left on the sorting surface of the table after the desired parts have been removed. The scrap material is removed from the tabletop sorting surface before another stock sheet containing parts is positioned for sorting. The scrap material is conveniently slid off any portion of the outer perimeter edge of the sorting surface or the tabletop, either during the sorting operation and/or after all parts have been removed. That is, scrap material can be removed by sliding material off the tabletop surface or simply tossing the scrap material off the perimeter edge of the tabletop at any point of the sorting process. The tabletop forming the sorting surface is positioned on a raised center structure having a frame for supporting the tabletop in a horizontal plane. The raised center structure rises from within and is arranged within a collection chute having one or more sloped wall surfaces for guiding scrap material to an exit opening at the bottom of the chute. The raised center structure can be at a level that ensures the tabletop sorting surface is arranged above and within the outer perimeter edge of the top opening of the collection chute such that scrap material can be slid off or tossed into the gap formed between the tabletop perimeter edge and outer perimeter of the top opening of the collection chute.

A storage means, such as a collection box or dump cart can be positioned below or integrally secured to the bottom opening of the collection chute to catch falling scrap material that can be removed from the area by moving the collection box from the table. The collection box can have suitable dimensions to match the opening at the bottom of the collection chute or, alternatively, be sized such that the box opening encompasses the opening to ensure no scrap material slides out of the chute and falls to the floor. The present table and related storage means assist with productivity and housekeeping improvements since the operators can easily slide either cut parts or scraps off the edge of the tabletop and into the collection carts. To assist in moving the collection box, wheels can be fixed to the collection box such that it can be easily moved from under the collection chute when full or between sorting operations.

In some embodiments, the collection chute can include one or more shelves arranged on one of its wall surfaces. The shelf faces inward towards the center of the chute and serves to catch material that has been removed from the tabletop. The shelves are ideally positioned to cantilever outward from an inner wall surface of the collection chute, preferably at a horizontal angle parallel to the tabletop sorting surface, and at a suitable distance, for example between 4 inches to 20 inches, to catch falling scrap material, for instance, scrap material sliding down the inner wall surface of the chute. The material on the shelves can provide an operator with the ability to check that no desired parts were removed from the tabletop surface. The shelves can have an optional lip or raised end section at the edge most inward to the center of the collection chute to prevent scrap material from further sliding off the shelf and into the bottom opening of the chute. The shelves can be have a solid surface or alternatively be perforated, made of netting or wire, or the like.

The shelves can be positioned on any or all walls of the collection chute, for example, a shelf can be located on one wall, two wall, three walls, or four walls. In another example, the collection chute body between the top opening and the bottom opening can have a singular shelf positioned around the entire inner perimeter such that all walls have a shelf surface extending inward to the center of the chute. The shelves on the walls of the collection chute can be arranged at any suitable distance below the top opening of the collection chute. Preferably, the shelves are within reach of an operator that is working on sorting parts on the tabletop surface. For example, the shelves can be positioned between 8 inches and 30 inches below the perimeter of the top opening of the collection chute.

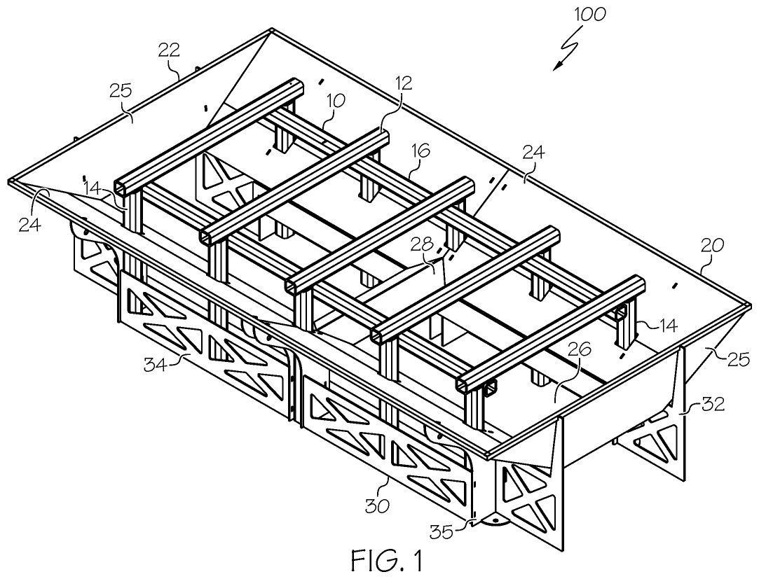

Several embodiments of the table are shown in FIGS. 1 through 3. As shown in FIG. 1, table 100 includes a center structure 10 arranged within a collection chute 20 for supporting a tabletop sorting surface within the top opening of the chute. The center structure 10 has a plurality of top members 12 arranged in parallel in series to form a support frame the tabletop sorting surface. As shown, the top members 12 are all positioned within and above the top perimeter surface 22 of the collection chute 20. A tabletop can be selected of appropriate size to rest on the plurality of top members 12 to sit within the top perimeter surface 22 of the chute 20 so scrap material can be slid off or removed from the tabletop and into the top opening of the chute 20.

The center structure 10 is constructed of multiple members, wherein top members 12 form a support plane for positioning a tabletop for forming a sorting surface for processing parts cut or stamped in stock sheets. Any suitable number of top members 12 can be used, for example, 2 to 10 top members, preferably arranged in an equally spaced manner along the top opening of the chute 20. The top members 12, as shown, are metal tubes having a hollow square cross-sectional shape. The members of the center structure can have any suitable cross-sectional shape, for example, square, rectangle, circular, etc. The support plane formed by the top members 12 can create a plane for the tabletop that is positioned below, above or in parallel with the top perimeter surface 22 of the chute 20 depending on the desired level of the sorting surface. Top members 12 can be arranged at any angle so long as they form a substantially horizontal plane for the tabletop to provide a useable sorting surface. As shown, top members 12 are positioned inside, in a non-contact manner, and perpendicular to the two sloped walls 24 of the collection chute 20. The top members 12 can be alternatively arranged to extend in parallel with walls 24 depending on the placement of base members 14. By arranging the top members 12 perpendicular with the two walls having the longest length, relative to end walls 25, the base members 14 can be positioned out of the middle of the collection chute 20 and prevent the bottom opening of the chute 20 from being blocked with members of the center structure 10.

Each top member 12 is attached to one or more base members 14 to provide a desired height to the top member 12 for forming a support plane for the tabletop. The base members 14, at their top end, can be mounted on the bottom or side of the top members 12, but do not affect the support plane formed by the top members 12. The base members 13 extend downward from the top members 12 towards the floor. The bottom end of the base members 14 can be secured to a wall portion of the collection chute 20, for instance, the sloped walls 24 of the collection chute 20 or, as shown, the base members 14 can extend through openings in the walls of the chute to rest against the floor and provide a support stand for center structure 10. The openings in the walls of the collection chute are ideally sized to provide minimal gap between the base member 14 outer perimeter surface and the openings. In some instances, the base members 14 can be welded to in the openings in the walls of the chute 20 or any gap between the openings and the base members 14 can be filled to prevent scrap material from falling to the floor.

One or more additional members can be used in the center structure 10 to provide a more rigid frame or supplemental support in select sections. For instance, support members 16 as shown in FIG. 1 can be secured at or near the junction of top members 12 and base members 14 to provide structural integrity and stability to center structure 10. The addition of support members 16 help to resist torquing of the center structure 10 and ensure the frame matrix can support sufficient weight on the tabletop surface while not bending or flexing. The support members 16 can be mounted to run perpendicular to the plurality of top members 12, for example, members 16 can be mounted along the bottom surface of each top members to provide a rectangular frame section. FIG. 1 shows two support members 16 connected to members 12 and 14 and, more particularly, positioned below and perpendicular to top members 12 and inside base members 14.

FIG. 1 illustrates top members 12 of center structure 10 being raised above the top opening of collection chute 20, which provides a user with a more ergonomic work surface when a tabletop is positioned on top of center structure 10. That is, the top perimeter surface of the walls of collection chute 20 do not impede arm movement of a user during sorting since the perimeter lip is positioned below, or at least parallel, with a tabletop sorting surface. In other embodiments, top members 12 of center structure 10 can be arranged below the top perimeter surface 22 of chute 20 such that the tabletop sorting surface can sit near or just below the top opening of the chute 20. Regardless of the tabletop position, a user should be equipped with the ease of discarding scrap material off of the tabletop surface and into the collection chute 20. To aid in this scrap discarding, the gap between the chute 20 top opening and perimeter edge of the tabletop surface should be sufficient enough to accommodate all scrap material dimensions but also abundant enough to provides an adequate openings that catches sliding material without portions of the scrap being flipped off the tabletop and onto the surrounding floor.

The body of collection chute 20 forms an open-top housing or top opening that surrounds center structure 10 and is designed to both catch and funnel the scrap material downward through the chute body to a central bottom opening where the scrap material is collected for disposal or further use. As shown, the body of chute 20 is formed by four walls 24, 25 that define a top opening and a bottom opening 26. The top opening has a larger diameter than the bottom opening, for example, the top opening can be 1.5, 2, 2.5, 3, 3.5, 4, 5 or 10 times larger than the bottom opening. In some embodiments, the top opening can have a metal lip formed around the perimeter to guide scrap material downward into the chute.

Walls 24 have a top edges that forms a portion of the top opening. Walls 24 are sloped inward towards center structure 10 and terminate at their bottom edge to define perimeter portions of bottom opening 26. Walls 24 are directed opposite one another and together form an angled funnel that guides scrap material away from the top opening and into bottom opening 26. Walls 24 can be sloped inward at any suitable angle, for example, 15 to 60 degrees, to promote scrap material sliding downward and through bottom opening 26 into a collection box (not shown). Walls 25 are adjacent both ends of walls 24 and cap the ends of the body of chute 20. Together, walls 24 and 25 form an enclosed hollow body of the chute. Walls 25 are shown as vertical, non-sloped walls and form two ends of chute 20. Alternatively, walls 25 can be sloped at any suitable angle and can be sloped at the same angle as walls 24.

In another option, the body of the chute 20 can include more than four walls to provide a non-square or rectangular shape, for instance, 6 walls or 8 walls. Any portion of the chute walls can be sloped as desired as well as the walls can have multiple sections as viewed from the top edge at the top opening to the bottom edge at the bottom opening. That is, a wall can be sloped inward at the top opening of chute 20 and then transition into another angle further down the wall surface. The walls can also have vertical and sloped sections as desired.

Chute 20 can further include a divider 28 positioned in bottom opening 26, which can divide the bottom opening into a first and second opening for feeding scrap material into one or more collection boxes below the openings. Divider 28 can be an angled piece of material having two sloped sides to direct scrap material into a first and second opening, which can be open to separate collection boxes. The sloped sides of divider 28 angle towards one another to form a peak that elevates into the body of chute 20. The peak contacts scrap material and forces the material to slide down either sloped face of the divider. As shown, divider 28 is centered in bottom opening 26, however, any suitable position along bottom opening 26 can be used for divider 28. Multiple dividers can also be arranged in bottom opening 26, for example, 2, 3 or 4 dividers can be used. Divider 28 also provides structural support for the chute body.

FIG. 1 shows table 100 Table 100 can further include an optional base structure 30 secured to side and bottom portions of chute 20. Base structure 30 can provide both structural integrity to table 100 as well as a greater footprint for contacting the ground for ensuring stability during use. As shown in FIG. 1, base structure 30 can be a lattice type of structure or frame that extends to the ground and contains multiple top brackets that contact the outer walls 24, 25 of chute 20 at support points. FIG. 1 shows base structure 30 having two lattice brackets 32 placed at and secured to each end of chute wall 25. Additional lattice walls 34 extend along sloped chute walls 24 and have brackets 35 that extend upward and are fixed to walls 24 at multiple support points. Any suitable arrangement of base structure components can be used to provide supplemental support to base members 14 for stabilizing table 100 during use.

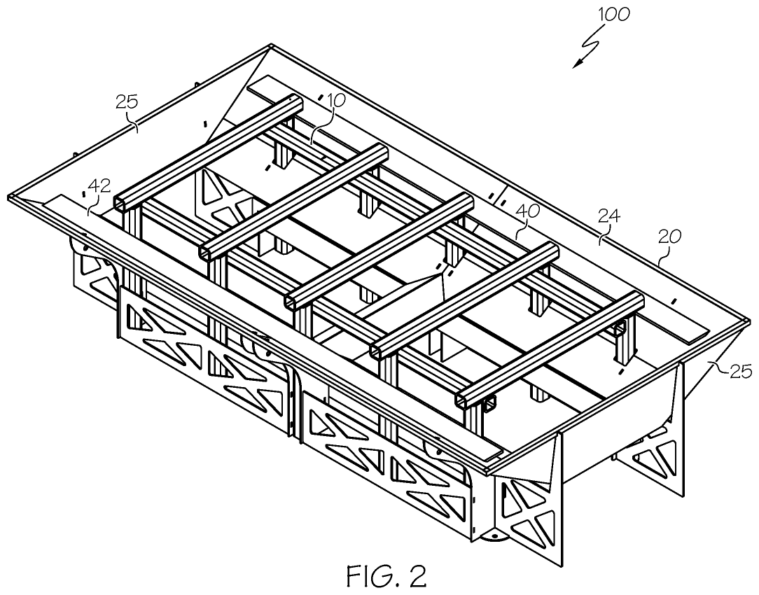

FIG. 2 illustrates another embodiment of table 100. Chute 20 can have a plurality of shelves arranged on the inner surface of walls 24, 25. As shown, a first shelf 40 and a second shelf 42 are secured to the inner surface of sloped walls 24. Shelves 40, 42 extend inward in a substantially horizontal plane such that they are cantilevered out from walls 24. The shelves 40, 42 can extend the entire length of any chute wall or, as depicted, extend a portion of the wall length. Although not shown, walls 25 can include shelves if desired. The vertical arrangement of shelves can vary and, as shown, shelves 40, 42 are positioned near the top half or top perimeter of walls 24 so scrap material or parts can be caught and inspected easily during sorting procedures. The shelves can extend inward at any suitable distance, for example, 6 to 30 inches depending on the size and shape of scrap material or parts being sorted.

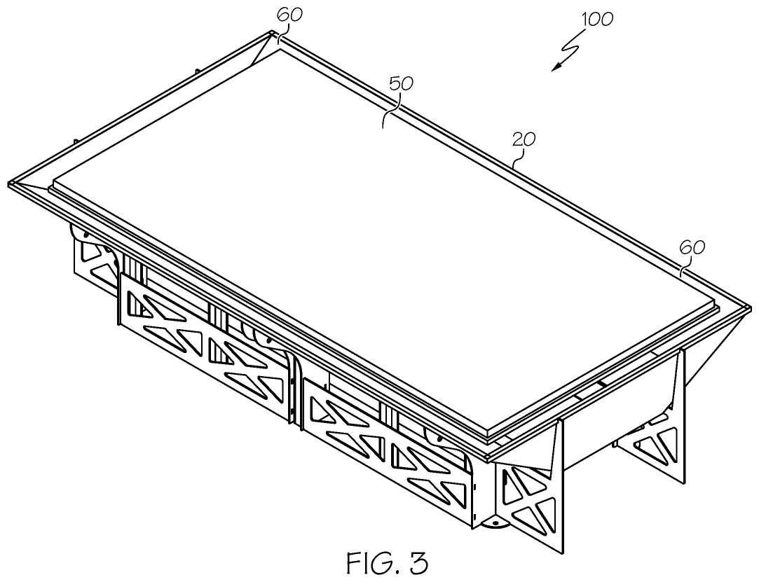

Further, FIG. 3 shows table top 50 positioned directed on center structure 10 to provide a sorting surface for laying sheet stock having parts to be removed and processed. Table top 50 rests on top members 12. If desired, table top 50 can be secured to one or more members of center structure 10 to ensure it does not move or slide during use. Preferably, table top 50 is a metal sheet with sufficient weight to provide a stable sorting surface that resists movement. Around the perimeter edge of table top 50 is a gap 60 that extends between the table top edge and the top perimeter edge of chute 20. Gap 60 provides an opening into chute 20 such that scrap material or parts can be moved off of table top 50 and fall into chute 20. Gap 60 can be any suitable size, for instance, gap 60 can be sized as desired by adjusting the size and dimensions of table top 50 to ensure that scrap material and/or parts can fit in gap 60 and fall into the interior region of chute 20.

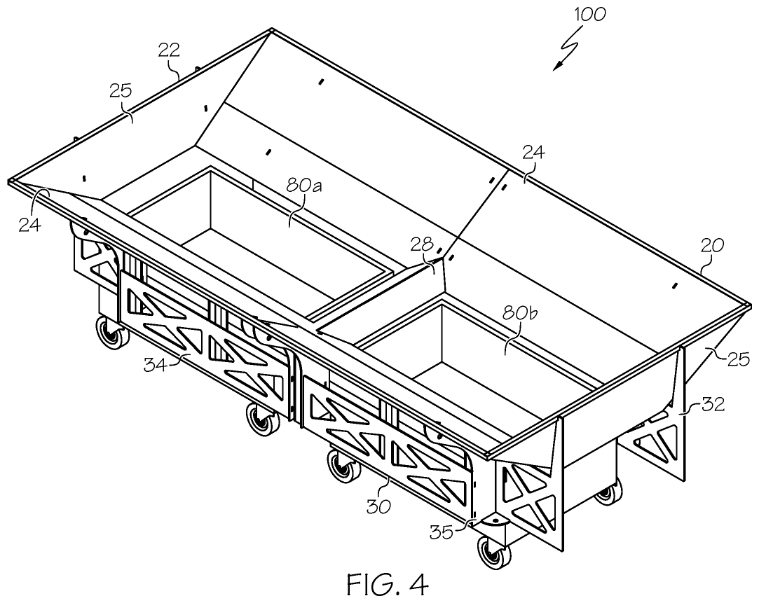

Lastly, FIG. 4 illustrates an embodiment of table 100 that includes two collection boxes 80a, 80b selectively positioned below the bottom opening of collection chute 20. Divider 28 positioned at the center of the bottom opening of chute 20 divides the bottom opening into a first opening and a second opening. As shown, collection box 80a is positioned below one half, either the first or second opening, of the bottom opening of chute 20. Collection box 80a has a top opening sized to encompass the one half of the chute's bottom opening as defined on either side of divider 28. In a similar manner, collection box 80b is positioned on the opposite of divider 28. Collection box 80b is sized to encompass either the first or second opening of the collection chute 20. Although not shown, each collection box 80a, 80b can be equipped with a lip or angled extension that extends from the upper opening of the box to prevent scrap material from exiting the bottom opening of chute 20 and not being secured in either box 80a, 80b, for example, scrap material that may escape from a gap between the bottom opening of the chute and the top opening of either box.

As shown in FIG. 4, each collection box 80a, 80b is equipped with four wheels such that the boxes can be moved from a first position below the bottom opening of chute 20 to a second position away from table 100, for example, to a scrap material collection area. Any suitable means for moving the boxes 80a, 80b can be used, which will equip a user with method for manually moving the boxes. In another example of a means for helping aid in the movement of the boxes, one or more side walls of the boxes 80a, 80b can be fitted with an attached handle or gripping device so a user can better grab and pull on the collection boxes for moving them out from under table 100. Certain types of scrap material, such as metal pieces, can accumulate in the boxes and add considerable weight that makes it difficult to move the boxes. Wheels, grips or a combination thereof help a user deal with the significant weight of full collection boxes during operation.

While various aspects and embodiments have been disclosed herein, other aspects and embodiments will be apparent to those skilled in the art. The various aspects and embodiments disclosed herein are for purposes of illustration and are not intended to be limiting.

1. An unloading table for sorting, the table comprising:
a. a tabletop having a first surface;
b. a center structure comprising
i. a frame arranged to support the tabletop in a horizontal plane; and
c. a collection chute comprising
i. a through passage that connects a top opening and a bottom opening, the through passage being formed by at least one sloped wall surface,
wherein a portion of the center structure is arranged within through passage of the collection chute.

2. The unloading table of claim 1, wherein the frame of the center structure comprises one or more top members, the one or more top members arranged within the top opening of the collection chute and the one or more top members directly support the tabletop.

3. The unloading table of claim 2, wherein the one or more top members of the frame are attached to a plurality of base members, the plurality of base members extend downward from the one or more top members.

4. The unloading table of claim 1, wherein a collection box is positioned below the bottom opening of the collection chute.

5. The unloading table of claim 4, wherein the collection box comprises a plurality of wheels suitable for moving the collection box.

6. The unloading table of claim 1, wherein the through passage of the collection chute comprises two sloped wall surfaces and at least two additional wall surfaces such that the two sloped wall surface and the at least two additional wall surfaces form the through passage and define the top perimeter surface of the top opening of the collection chute.

7. The unloading table of claim 1, wherein the bottom opening of the collection chute comprises a divider that sections the bottom opening into a first opening and a second opening.

8. The unloading table of claim 7, wherein the divider comprises a sloped surface, the sloped surface is angled downward relative to the first surface of the tabletop arranged on the frame of the center structure.

9. The unloading table of claim 1, wherein the top opening of the collection chute has a top perimeter surface, and the first surface of the tabletop is positioned within the top perimeter surface.

10. The unloading table of claim 9, wherein the first surface of the tabletop is positioned below the top perimeter surface of the top opening of the collection chute.

11. The unloading table of claim 9, wherein the first surface of the tabletop is positioned above the top perimeter surface of the top opening of the collection chute.

12. The unloading table of claim 9, wherein a gap exists between a perimeter of the first surface of the tabletop and the top perimeter of the top opening of the collection chute.

13. The unloading table of claim 1, wherein the at least one sloped wall surface of the through passage of the collection chute extends from outside a perimeter of the first surface of the tabletop to below the first surface of the tabletop and within the perimeter of the first surface.

14. The unloading table of claim 1, wherein the through passage of the collection chute comprises a shelf that extends inward along a horizontal plane from the sloped wall surface.

15. An unloading table for sorting, the table comprising:
a. a tabletop having a first surface and a second surface;
b. a center structure arranged to support the tabletop, the center structure comprising
i. a frame comprising a plurality of top members, the plurality of top members support the tabletop in a horizontal plane by contacting the second surface of the tabletop;
ii. the plurality of top members are joined to base members that extend downward from the plurality of top members; and
c. a collection chute comprising
i. a through passage formed by four or more walls, at least one of the four or more walls having a sloped surface relative to the horizontal plane of the tabletop;
ii. a top opening at one end of the through passage and a bottom opening at an opposite second end of the through passage, the top opening having a top perimeter surface and the bottom opening having a bottom perimeter surface; and
wherein the plurality of top members of the center structure is positioned within top perimeter surface of the through passage of the collection chute.

16. The unloading table of claim 15, wherein the through passage of the collection chute has a shelf positioned the at least one sloped wall surface, the shelf extending inward into the through passage along a horizontal plane and the shelf is positioned below the tabletop.

17. The unloading table of claim 16, wherein the shelf can be comprised of a solid metal surface, a metal frame with netting, a wire structure, or a combination thereof.

18. The unloading table of claim 15, wherein a gap exists between a perimeter of the first surface of the tabletop and the top perimeter of the top opening of the collection chute.

19. The unloading table of claim 15, wherein bottom opening of the through passage of the collection chute is positioned above the ground and a collection box is positioned below the bottom opening of the collection chute.

20. The unloading table of claim 15, wherein the top opening has a larger perimeter than the bottom opening, and the perimeter of the bottom opening is smaller than a perimeter of the tabletop.
